(19) United States
(12) Patent Application Publication
(10) Pub. No.: US 2013/0018663 A1
(43) Pub. Date: Jan. 17, 2013

(54) Connecting Consumers with Providers

(71) Applicant: Roy Schoenberg, Boston, MA (US)

(72) Inventor: Roy Schoenberg, Boston, MA (US)

(73) Assignee: American Well Corporation

(21) Appl. No.: 13/181,497

(22) Filed: Jul. 12, 2011

(51) Int. Cl. G06Q 10/00

(52) U.S. Cl. 705/1.1

(57) ABSTRACT

A computer-implemented method includes receiving, from a computing device used by a first service provider, a request for an available second service provider, with a device used by the first service provider having a first communication channel established with a device used by a consumer of services; determining one or more available second service providers; establishing, based on selection of an available second service provider, a second communication channel between a device used by the selected second service provider and the device used by the first service provider; receiving, from the device used by the first service provider, a request to bridge the first communication channel and the second communication channel; and bridging the first communication channel and the second communication channel.

### BACKGROUND

Systems have been developed to provide services that connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued U.S. Pat. No. 7,590,550, which is incorporated herein by reference.

### SUMMARY

In one aspect of the present disclosure, a computer-implemented method includes receiving, from a computing device used by a first service provider, a request for an available second service provider, with a device used by the first service provider having a first communication channel established with a device used by a consumer of services; determining one or more available second service providers; establishing, based on selection of an available second service provider, a second communication channel between a device used by the selected second service provider and the device used by the first service provider; receiving, from the device used by the first service provider, a request to bridge the first communication channel and the second communication channel; and bridging the first communication channel and the second communication channel.

Implementations of the disclosure may include one or more of the following features. In some implementations, one or more of the device used by the consumer of services, the device used by the first service provider, and the device used by the second service provider comprises a telephonic device. In other implementations, one or more of the device used by the consumer of services, the device used by the first service provider, and the device used by the second service provider comprises a computing device.

In still other implementations, one or more of the first communication channel and the second communication channel comprises a voice-based communication channel. In some implementations, one or more of the first communication channel and the second communication channel comprises a text-based communication channel. In still other implementations, the method includes receiving information indicative of contact information for the device used by the consumer of services. In some implementations, the method also includes establishing, using the information indicative of the contact information, a connection between the device used by the consumer of services and the brokerage system, wherein bridging comprises: joining the connection with the second communication channel. In still another implementation, the first communication channel comprises a connection with the device used by the consumer, and bridging comprises: joining the connection with the second communication channel.

In another aspect of the disclosure, one or more machine-readable media are configured to store instructions that are executable by one or more processing devices to perform operations including receiving, from a computing device used by a first service provider, a request for an available second service provider, with a device used by the first service provider having a first communication channel established with a device used by a consumer of services; determining one or more available second service providers; establishing, based on selection of an available second service provider, a second communication channel between a device used by the selected second service provider and the device used by the first service provider; receiving, from the device used by the first service provider, a request to bridge the first communication channel and the second communication channel; and bridging the first communication channel and the second communication channel. Implementations of this aspect of the present disclosure may include one or more of the foregoing features.

In still another aspect of the disclosure, an electronic system includes one or more processing devices; and one or more machine-readable media configured to store instructions that are executable by the one or more processing devices to perform operations including: receiving, from a computing device used by a first service provider, a request for an available second service provider, with a device used by the first service provider having a first communication channel established with a device used by a consumer of services; determining one or more available second service providers; establishing, based on selection of an available second service provider, a second communication channel between a device used by the selected second service provider and the device used by the first service provider; receiving, from the device used by the first service provider, a request to bridge the first communication channel and the second communication channel; and bridging the first communication channel and the second communication channel. Implementations of this aspect of the present disclosure may include one or more of the foregoing features.

### BRIEF DESCRIPTION OF THE FIGURES

FIG. 1 shows a system for establishing multi-party communication channels.

FIGS. 2, 3, and 4 are flow charts of processes used in the system.

FIG. 5 is a block diagram of a computer (computer system) showing exemplary components that can be used for the brokerage system and/or client devices.

### DETAILED DESCRIPTION

The system described below provides a communication platform that establishes a communication channel among a consumer of services and service providers, for example, among a patient, a nurse and a physician. In an example, a patient calls through a telephonic communication channel (web or switched-network based) into a wellness call center (e.g., a nurse call center) to speak with a service provider, e.g., a nurse about the patient's medical condition. The wellness call center transfers the patient to a nurse.

Through the communication channel established by the wellness call center, the nurse converses with the patient. During the conversation, the nurse decides that consulting with a physician would be helpful to the patient. The nurse accesses the system described below and requests a consultation with an available physician. The system identifies an available physician and establishes a communication channel between computing devices used by the physician and by the nurse, respectively. Through the established communication channel, the nurse debriefs the physician on the patient's current medical condition. Following debriefing, the nurse uses the system to establish a multi-party communication channel (e.g., a three-way communication channel) among devices used by the nurse, the physician, and the patient, respectively. These devices include telephonic devices and/or computing devices. The system establishes a three-way communication channel using, e.g., a telephonic three-way communication channel, an online three-way communication channel, a network-based communication channel, and so forth.

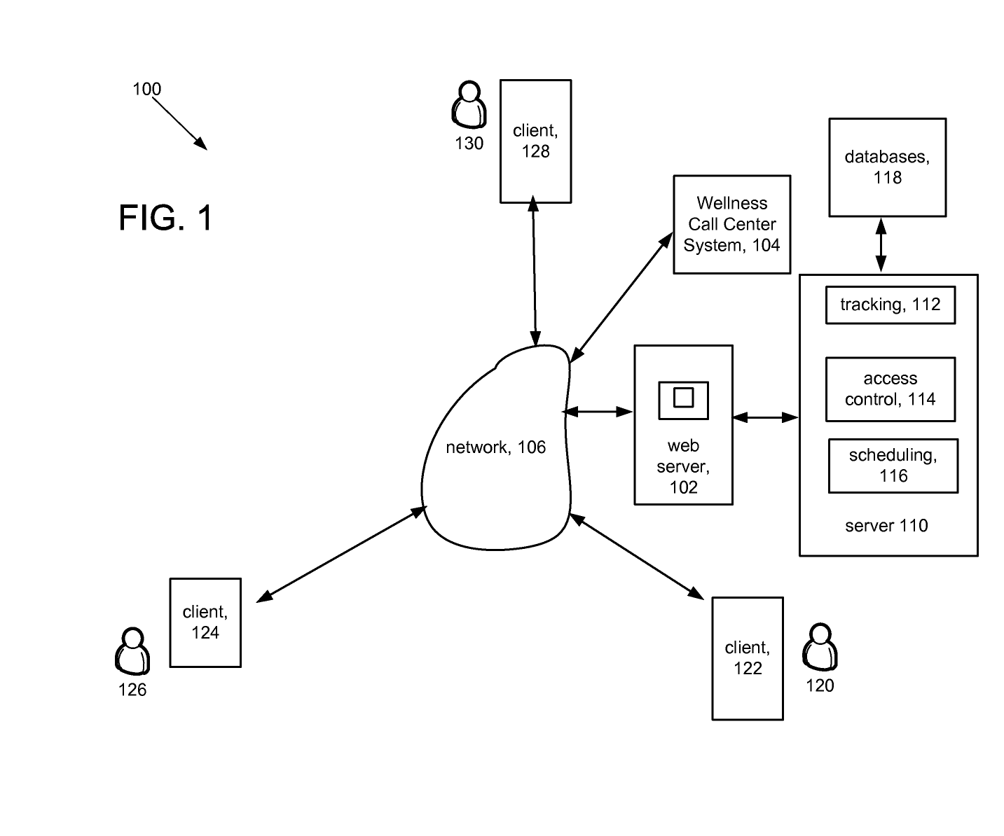

FIG. 1 shows an example environment 100 for establishing multi-party communication channels. The environment 100 includes a computerized brokerage system or server 110 for making connections between consumers 120, at client devices 122, and service providers 126, 130, at client devices 124, 128 over a network 106, e.g., the Internet or other types of networks. Client devices 122, 124, 128 can be any combination of, e.g., personal digital assistants, land-line telephones, cell phones, computer systems, media-player-type devices, and so forth. Client devices 122, 124, 128 enable consumers 120 and the service providers 126, 130 to input and to receive information as well as to communicate via video, audio, and/or text with each other.

System 110 may operate as a service running on web server 102. The components of system 110 and web server 102 may be integrated or distributed in various combinations as is known in the art. System 110 accesses one or more databases 118. Environment 100 also includes wellness call center system 104. In an example, wellness call center system 104 is a telephonic and/or a computerized system that establishes a communication channel between a patient and a service provider, e.g., a nurse.

In the example of FIG. 1, wellness call center system 104 is external to brokerage system 110. Wellness call center system 104 is a third-party system operated by a party that differs from the party operating brokerage system 110.

A communication channel is established through wellness call center system 104 between client device 124 (e.g., used by service provider 126) and client device 122 (e.g., used by consumer 120). During the communication with consumer 120, service provider 126 decides to bring service provider 130 into the consultation with consumer 120. Service provider 126 uses client device 124 to access brokerage system 110 and to request a consultation with service provider 130. In response to the request, brokerage system 110 establishes a communication channel between client devices 124, 128 to enable communication between service providers 126, 130. Through the communication channel, service provider 126 debriefs service provider 130 on the symptoms/conditions experienced by consumer 130.

Following debriefing by service provider 126, one of the service providers, typically service provider 126, initiates establishment of a three-way communication channel among client devices 122, 124, 128, e.g., sending a request to the brokerage system to have the brokerage system bridge the communication channel between client devices 122, 124 with the communication channel between client devices 124, 128. To bridge the communication channels, brokerage system 110 joins the two established communication channels (between client devices 122, 124) and (between client devices 124, 128). After completion of bridging the calls, client devices 122, 124, 128 are connected to each other through brokerage system 110, as described in further detail below.

Rather than connecting established communication channels with each other, brokerage system 110 is also configured to establish a three-way communication channel by establishing another communication channel between client devices 122, 130. To establish the communication channel between client devices 122, 130, brokerage system 110 receives from wellness call center system 104 contact information for client device 122 used by consumer 120, including, e.g., a telephone number for client device 122, an Internet Protocol (“IP”) address of client device 122, and so forth. Using the contact information for client device 122, brokerage system 110 establishes a communication channel between client devices 122, 128. Brokerage system 110 implements the bridging functionality to join the communication channel between client devices 122, 128 to the communication channel between client devices 124, 128 to establish the three-way communication channel among client devices 122, 124, 128.

Brokerage system 110 also includes an availability or presence tracking module 112 for tracking the availability of service providers 130. Availability or presence is tracked actively or passively. In an active system, one or more of the service providers 130 provides an indication to brokerage system 110 that the one or more service providers are available to be contacted by consumers 120 and/or by service providers 126 and an indication of the mode by which the provider may be contacted. In some examples of an active system, the provider's computer, phone, or other terminal device periodically provides an indication of the provider's availability (e.g., available, online, idle, busy) to the system 110 and a mode (e.g., text, voice, video, etc.) by which the provider can be engaged. In a passive system, brokerage system 110 presumes that the service provider 130 is available by the service provider's actions, including connecting to brokerage system 110 or registering the provider's local phone number with the system. In some examples of a passive system, the system 110 indicates the provider 130 to be available at all times until the provider logs off, except when the provider is actively engaged with a consumer 120 and/or with another service provider 126.

Providers are, however, often available at times that are not convenient for their consumers, for example, in the event of a last-minute cancellation. Providers also may be available during otherwise idle times, such as when home. The brokerage supplements existing provider availability to allow whichever providers are available at any given time engage in a consultation with another service provider and a consumer at the request of the other service provider. Instead of relying on the unlikely availability of a specific provider for any given consumer, the brokerage connects service provider 126 to all online providers 130 capable of addressing the needs of consumer 120. The brokerage has distinct features including the ability to engage in live communication with a suitable, selectable provider and the ability to do so at the request of another service provider 126.

The system assists service provider 126 in navigating to an appropriate service provider 130. Service provider 126 select to engage with the next available service provider 130 in a given service provider domain (e.g., service provider 126 can choose to connect to the next available dermatologist).

Brokerage system 110 provides information and services to service providers 126 in addition to connecting them with providers 130. The brokerage system 110 includes an access control facility 114, which manages and controls whether a given service provider 126 and/or wellness call center system 104 may access system 110 and what level or scope of access to the features, functions, and services system 110 will provide.

Brokerage system 110 facilitates communication between consumer 120 and providers 126, 130, enabling them to communicate, for example, via a data-network-facilitated video or voice communication channel (such as Voice over IP), land and mobile telephone network channels, and instant messaging or chat. The availability of one or more providers 130 is tracked, and at the instant another service provider 126 desires to connect and engage in a consultation with a provider, the system 110 determines whether a provider is available. If a particular provider 130 is available, the system 110 assesses the various modes of communication that are available (e.g., based on common modes and modes preferred by the provider) and connects provider 126 and the provider 130 through one or more of the common modes of communication.

In addition, the system selects a mode of communication to use based in part on the relative utility of the various modes. The preferred mode for an engagement is for both the provider 126 and the provider 130 to use web-based consoles, as this allows each of the other modes to be used as needed. For example, the provider 126 and the provider 130 may launch chat sessions, voice calls, or video chats from within a web-based console. If the provider 130 is not available, the system 110 identifies other available providers 130 that would meet the needs of consumer 120 as determined by service provider 126. The system 110 enables the service provider 126 to send a message to the consumer's chosen provider. The service provider 126 can also have the system 110 contact the service provider 126 in the future when the chosen provider is available.

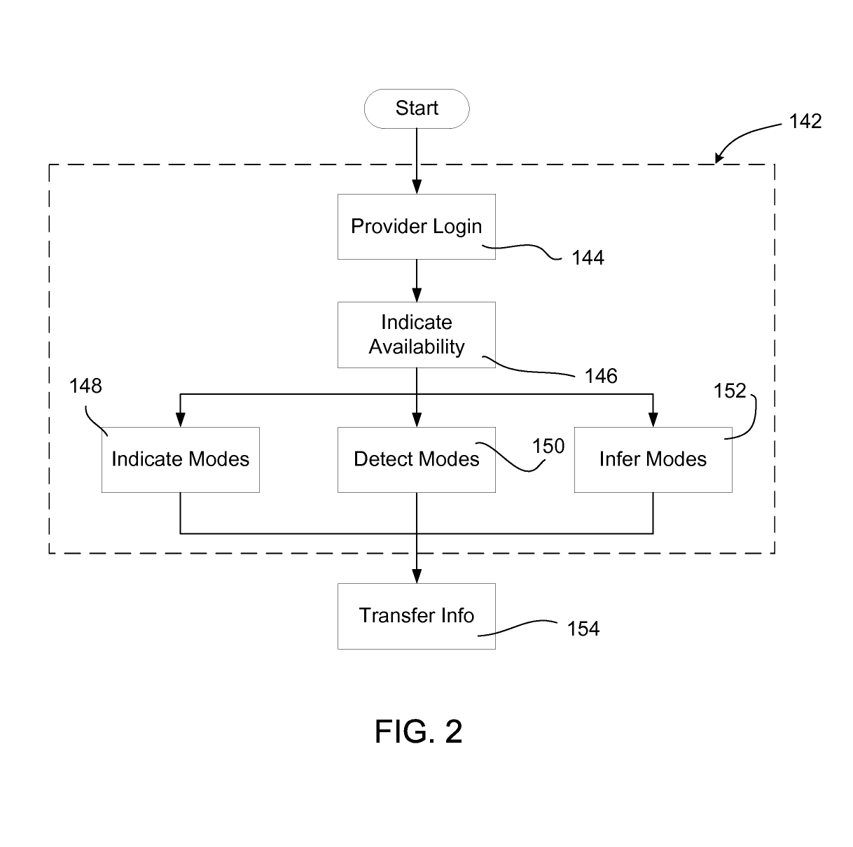

Referring now to FIG. 2, the brokerage system 110 tracks 142 the availability of providers 130. When a provider 130 logs 144 into system 110, the provider 130 indicates 146 (such as by setting a check box or selecting a menu entry or by responding to a voice prompt) to the tracking module 112 that he or she is available to interact with consumers 120 and/or providers 126. The provider 130 can also indicate 148 to the tracking module 112 (such as by setting a check box or selecting a menu entry or by responding to a voice prompt) the modes (e.g., telephone, chat, video conference) by which consumers 120 and/or providers 126 can be connected to the provider 130. Alternatively, the tracking module 114 determines 150 the capabilities of the terminals 124, 128 the providers 126, 130 use to connect to the system (for example, by using a terminal-based program to analyze the hardware configuration of each terminal). Thus, if a provider 130 connects to the system 110 by a desktop computer and the provider has a video camera connected to that computer, the tracking module 112 determines 150 that the provider 130 can be engaged by text (e.g., chat or instant messenger), voice (e.g., VoIP) or video conference. Similarly, if a provider 130 connects to the system using a handheld device such as a PDA, the tracking module 112 determines 152 that the provider 130 can be engaged by text or voice. The tracking module 112 can also infer 152 a provider's availability and modes of engagement by the provider's previously provided profile information and the terminal device through which the provider connects to the system.

Providers participating in the brokerage network can have several states of availability over time. States in which the provider may be available may include on-line, in which the provider is logged-in and can accept new engagements in any mode, on-line (busy), in which the provider is logged-in but is currently occupied in a video or telephonic engagement, and scheduled, in which the provider is offline but is scheduled to be online at a designated time-point and can pre-schedule engagements for it. While not online, the provider can take messages as in offline state. Other states may include off-line, in which the provider is not logged in but can take message-based engagements (i.e., asynchronous engagements), out-of-office, in which the provider is not accepting engagements or messages, and standby, in which the provider is offline and can be paged to Online status by the brokerage network if traffic load demands it (in some examples, consumers see this state as offline).

The tracking module 112 transfers 154 information about the availability and the communication capability of the consumers 120 and the providers 126, 130 to the scheduling module 116 using, for example, one or more well-known presence protocols, such as Instant Messaging and Presence Service (IMPS), Session Initiation Protocol (SIP) for Instant Messaging and Presence Leveraging Extensions (SIMPLE), and the Extensible Messaging and Presence Protocol (XMPP).

As noted, the system 110 includes access control facilities 114 that control how service providers 126 and/or wellness call center system 104 access the system and to what extent or level the services provided by the system are made available to service providers 126 and/or wellness call center system 104. The system 110 also stores and provides access to consumer information (e.g., contact information, and preference/profile information to be described later). However, other consumer information would typically be not accessible to the service provider, such as credit rating information, financial information, and credit card information. Similarly, provider information (e.g., biographies, product and service information, and any information the provider wants to make available to consumers) can be made available. The access control facility 114 would prevent unauthorized access to this information.

While the system can assist provider 126 in identifying the most appropriate providers, it also allows provider 126 to filter the provider list based on his preference and access a view of a provider availability matrix that changes as providers go on and off line.

Various criteria are used to filter the available providers. Basic details indicate preference for the type and gender of the provider and what modes of communication to be used. Provider 126 can also specify demographics including location and languages spoken. Qualifications may include years of experience and various other criteria. Provider 126 can also use a search box to search for a provider by name.

Providers 126 may select providers 130 according to the type of consultation that is sought and attributes of the provider, such as a geographical area where the provider is located. Any metrics within the provider profile (discussed below) can be used to define a list of providers that meet the consumer's preferences.

Once provider 126 enters search criteria, the results are shown on the web page. As mentioned, a list of providers is presented. This list may indicate each providers name and rating and whether the provider is available. For the selected provider, additional details are shown, including her picture, specialty, demographic information, what types of connections she can use for an engagement, and personal information. Tools allow the consumer to initiate or schedule an engagement and/or view a live video/audio.

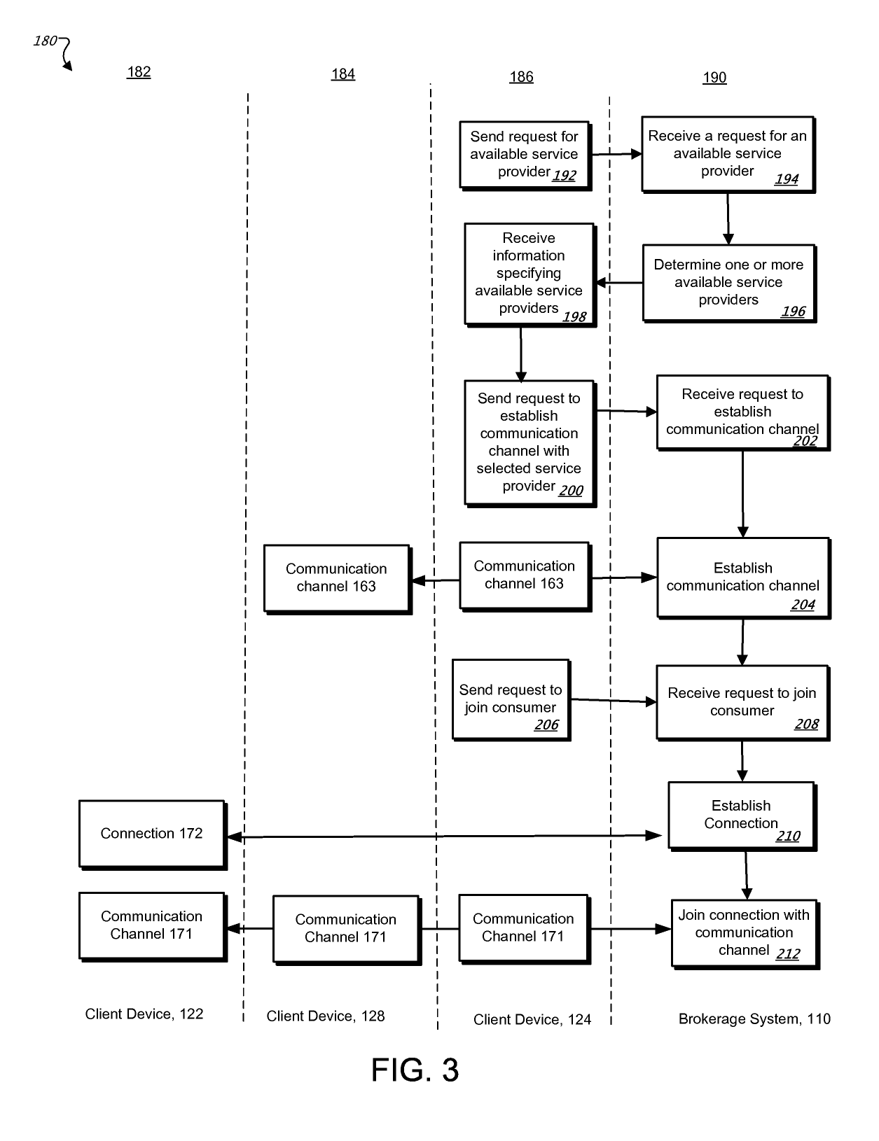

FIG. 3 is a flow chart of example process 180 for establishing communication channel 171 among client devices 122, 124, 128. Process 180 includes client side processes 182, 184, 186 performed on client devices 122, 128, 124, respectively and a server side process 190 performed on brokerage system 110.

In operation, client device 124 sends (192) a request to brokerage system 110 for an available service provider to join a consultation with service provider 126 and consumer 120. Brokerage system 110 receives (194) the request for an available service provider to join the consultation. In response, brokerage system 110 determines (196) one or more available service providers. In an example, service provider 126 requests available service providers associated with specified attributes that define a suitable service provider acceptable for the consultation, as previously described.

Client device 124 receives (198) information specifying the available service providers that match the specified attributes. Service provider 126 selects service provider 130 and client device 124 sends (200) to brokerage system 110 a request to establish a communication channel with client device 128 used by service provider 130. Brokerage system 110 receives (202) from client device 124 used by service provider 126 the request to establish the communication channel. Brokerage system 110 establishes (204) communication channel 163 between client devices 124, 128. Communication channel 163 includes one connection between client device 128 and brokerage system 110 and another connection between client device 124 and brokerage system 110.

Through communication channel 163, service provider 126 debriefs service provider 130 on the symptoms and/or conditions of consumer 120. Following the debriefing, service provider 126 initiates a request to join consumer 120 and service provider 130 in a multi-party communication. Client device 124 sends (206) brokerage system 110 a request to join client device 122 to communication channel 163. Brokerage system 110 receives (208) the request. In response, brokerage system 110 establishes (210) connection 172 with client device 122. Connection 172 may be a connection between client device 122 and system 104 that is moved over to brokerage system 110. Connection 172 may also be a new connection established by brokerage system 110 with client device 122. Brokerage system 110 also joins (212) connection 172 with communication channel 163 to generate communication channel 171.

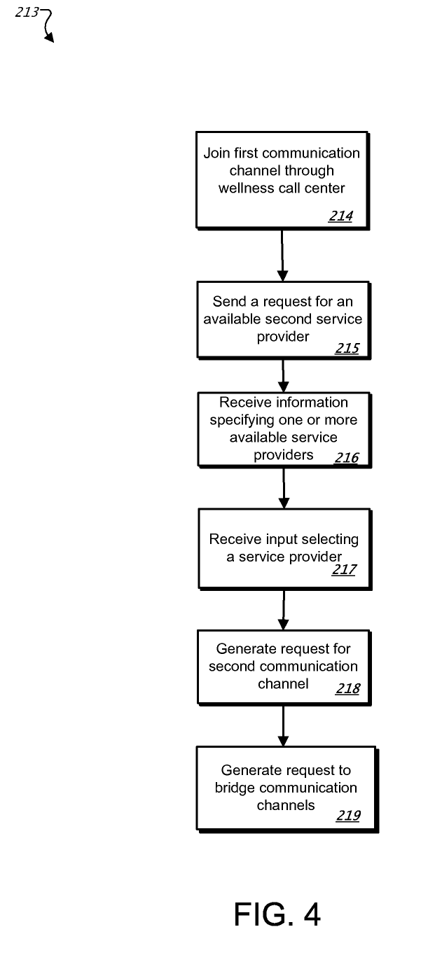

FIG. 4 is a flow chart of example process 213 for initiating establishment of communication channel 171 among client devices 122, 124, 128. In operation, wellness call center system 104 establishes (not shown) a communication channel (referred to herein as a “first communication channel,” without limitation, for purposes of convenience) between client devices 122, 124. Client device 124 joins (214) the first communication channel with system 104. The first communication channel is a telephonic communication channel, a network-based communication channel (e.g., via the Internet), and so forth. The first communication channel includes two connections, a connection between client device 122 and system 104 and another connection between client device 124 and system 104.

Through the first communication channel, service provider 126 uses client device 124 to engage in a communication with consumer 120 using client device 122. During the communication, service provider 126 decides that it would be helpful to join service provider 130 with the communication between service provider 126 and consumer 120. Service provider 126 uses client device 124 and sends (215) a request to brokerage system 110 for service provider 130 to join the communication.

Service provider 126 requests a consultation with service provider 130 using numerous attributes associated with service provider 130, including, e.g., name information, attributes that service provider 126 has determined would be helpful in assisting service provider 126 in the consultation with consumer 120, and so forth. For example, if consumer 120 describes to service provider 126 that consumer 120 has concerns with a mole, service provider 126 sends to brokerage system 110 a request for a consultation with a service provider having attributes indicative of dermatology expertise (e.g., a dermatologist).

Based on the attributes in a request for a service provider, brokerage system 110 determines one or more suitable and available service providers, namely, service providers qualified for the consultation with service provider 126 and/or matching certain attributes specified by service provider 126. Client device 124 receives (216) from brokerage system 110 information specifying one or more available service providers. Service provider 126 requests a communication with suitable service provider 130 through brokerage system 110. In particular, client device 124 receives (217) input selecting a service provider and generates (218) a request for a communication channel, namely, communication channel 163.

In response, brokerage system 110 establishes communication channel 163 between client device 124 used by service provider 126 and client device 128 used by service provider 130. Communication channel 163 includes two connections, a connection between client device 124 and brokerage system 110, and another connection between client device 128 and brokerage system 110.

Through communication channel 163, service provider 126 briefs service provider 130 on the symptoms and/or conditions of consumer 120. Following debriefing, service provider 126 decides that service provider 130 has received enough information to join the communication between service provider 126 and consumer 120 and sends a request to brokerage system 110 to establish a communication among service providers 126, 130 and consumer 120. In particular, client device 124 generates (219) a request to bridge communication channels that are already established among client devices 122, 124, 128.

To establish the requested communication, brokerage system 110 establishes connection 172 between client device 122 and brokerage system 110. Brokerage system 110 joins connection 172 to communication channel 163, thereby generating a communication channel among client devices 122, 124, 128. Once connection 172 has been established, brokerage system 110 sends system 104 an indication that connections between client devices 122, 124 and system 104 may be dropped from system 104.

Brokerage system 110 establishes connection 172 in numerous ways. For example, brokerage system 110 establishes connection 172 by moving a connection between client device 122 and system 104 over to brokerage system 110. Brokerage system 110 is configured to move a connection from system 104 when system 104 is part of brokerage system 110, and brokerage system 110 has control over the connection to join the connection with communication channel 163.

Brokerage system 110 also establishes connection 172 by establishing a new connection between client device 122 and brokerage system 110, e.g., rather than joining a connection already established with system 104. Brokerage system 110 establishes connection 172 using contact information for client device 122. When brokerage system 110 receives from client device 124 a request to establish communication among client devices 122, 124, 128, brokerage system 110 sends a request to system 104 for contact information of client device 122 used by consumer 120. Contact information includes an online screen name, a telephone number, an IP address and any other identifying information which may be used to establish a connection with client device 122.

Using the contact information, brokerage system 110 generates connection 172 between brokerage system 110 and client device 122 used by consumer 120. Through connection 172 and communication channel 163, brokerage system 110 establishes a multi-party communication channel (e.g., communication channel 171) among client device 124 used by service provider 126, client device 128 used by service provider 130 and client device 122 used by consumer 120.

Communication channel 171 includes communication channel 163 and connection 172. Communication channel 171 includes numerous types of communication channels, including e.g., a network-based communication channel (e.g., when client devices 122, 124, 128 are computing devices), a telephonic communication channel (e.g., when client devices 122, 124, 128 are telephonic devices), and so forth.

In a variation, a communication channel differing from communication channel 171 is maintained between client devices 124, 128. Through the communication channel differing from communication channel 171, service providers 126, 130 engage in a communication that is separate from the communication engaged in by service providers 126, 130 and consumer 120. Additionally, through the communication channel differing from communication channel 171, service providers 126, 130 engage in a different type of communication from the type of communication engaged in by service providers 126, 130 and consumer 120.

For example, communication channel 171 is a telephonic communication channel when client device 122 is a telephonic device and client devices 124, 128 are computing devices with telephonic capabilities. To promote an instant messaging communication between service providers 126, 130, brokerage system 110 also establishes between client devices 124, 128 a communication channel that differs from communication channel 171. Through the communication channel that differs from communication channel 171, service providers 126, 130 engage in an instant messaging communication while also engaging in a telephonic communication with consumer 120 via communication channel 171.

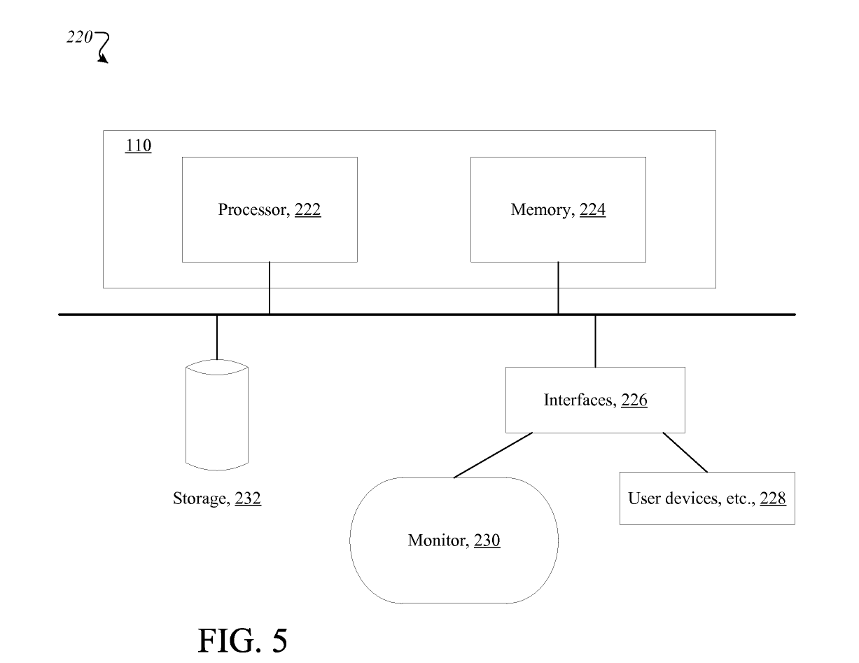

FIG. 5 is a block diagram of components 220 of the engagement brokerage system. User devices 228 can be any sort of computing device capable of taking input from a user and communicating over a network (not shown) with server 110 and/or with other client devices. For example, user device 228 can be a mobile device, a desktop computer, a laptop, a cell phone, a personal digital assistant (“PDA”), a server, an embedded computing system, a mobile device and so forth. User devices 228 include monitor 230 which render visual representations of interface 226.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from client device 228 via interfaces 226, including, e.g., graphical user interfaces. Interfaces 226 can be any type of interface capable of receiving information over a network, such as an Ethernet interface, a wireless networking interface, a fiber-optic networking interface, a modem, and so forth. Server 110 also includes a processor 222 and memory 224. A bus system (not shown), including, for example, a data bus and a motherboard, can be used to establish and to control data communication between the components of server 110.

Processor 222 may include one or more microprocessors. Generally, processor 222 may include any appropriate processor and/or logic that is capable of receiving and storing data, and of communicating over a network (not shown). Memory 224 can include a hard drive and a random access memory storage device, such as a dynamic random access memory, machine-readable media, or other types of non-transitory machine-readable storage devices.

Components 500 also include storage device 232, which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the description claims. In an example, the brokerage services described herein may be applied to numerous, different types of service providers, including, e.g., medical professionals, physicians, nurses, and so forth. In another example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprising:
receiving, from a computing device used by a first service provider, a request for an available second service provider, with a device used by the first service provider having a first communication channel established with a device used by a consumer of services;
determining, by a brokerage system, one or more available second service providers;
establishing, by the brokerage system based on selection of an available second service provider, a second communication channel between a device used by the selected second service provider and the device used by the first service provider;
receiving, from the device used by the first service provider, a request to bridge the first communication channel and the second communication channel; and
bridging, by the brokerage system, the first communication channel and the second communication channel.

2. The computer-implemented method of claim 1, wherein one or more of the device used by the consumer of services, the device used by the first service provider, and the device used by the second service provider comprises a telephonic device.

3. The computer-implemented method of claim 1, wherein one or more of the device used by the consumer of services, the device used by the first service provider, and the device used by the second service provider comprises a computing device.

4. The computer-implemented method of claim 1, wherein one or more of the first communication channel and the second communication channel comprises a voice-based communication channel.

5. The computer-implemented method of claim 1, wherein one or more of the first communication channel and the second communication channel comprises a text-based communication channel.

6. The computer-implemented method of claim 1, further comprising:
receiving information indicative of contact information for the device used by the consumer of services.

7. The computer-implemented method of claim 6, further comprising:
establishing, using the information indicative of the contact information, a connection between the device used by the consumer of services and the brokerage system.

8. The computer-implemented method of claim 7, wherein bridging comprises:
joining the connection with the second communication channel.

9. The computer-implemented method of claim 1, wherein the first communication channel comprises a connection with the device used by the consumer, and wherein bridging comprises:
joining the connection with the second communication channel.

10. One or more machine-readable media configured to store instructions that are executable by one or more processing devices to perform operations comprising:
receiving, from a computing device used by a first service provider, a request for an available second service provider, with a device used by the first service provider having a first communication channel established with a device used by a consumer of services;
determining one or more available second service providers;
establishing, based on selection of an available second service provider, a second communication channel between a device used by the selected second service provider and the device used by the first service provider;
receiving, from the device used by the first service provider, a request to bridge the first communication channel and the second communication channel; and
bridging the first communication channel and the second communication channel.

11. The one or more machine-readable media of claim 10, wherein one or more of the device used by the consumer of services, the device used by the first service provider, and the device used by the second service provider comprises a telephonic device.

12. The one or more machine-readable media of claim 10, wherein one or more of the device used by the consumer of services, the device used by the first service provider, and the device used by the second service provider comprises a computing device.

13. The one or more machine-readable media of claim 10, wherein one or more of the first communication channel and the second communication channel comprises a voice-based communication channel.

14. The one or more machine-readable media of claim 10, wherein one or more of the first communication channel and the second communication channel comprises a text-based communication channel.

15. The one or more machine-readable media of claim 10, wherein the operations further comprise:
receiving information indicative of contact information for the device used by the consumer of services.

16. The one or more machine-readable media of claim 15, wherein the operations further comprise:
establishing, using the information indicative of the contact information, a connection between the device used by the consumer of services and the brokerage system.

17. The one or more machine-readable media of claim 16, wherein bridging comprises:
joining the connection with the second communication channel.

18. An electronic system comprising:
one or more processing devices; an
one or more machine-readable media configured to store instructions that are executable by the one or more processing devices to perform operations comprising:
receiving, from a computing device used by a first service provider, a request for an available second service provider, with a device used by the first service provider having a first communication channel established with a device used by a consumer of services;
determining one or more available second service providers;
establishing, based on selection of an available second service provider, a second communication channel between a device used by the selected second service provider and the device used by the first service provider;
receiving, from the device used by the first service provider, a request to bridge the first communication channel and the second communication channel; and
bridging the first communication channel and the second communication channel.

19. The electronic system of claim 18, wherein the operations further comprise:
receiving information indicative of contact information for the device used by the consumer of services.

20. The electronic system of claim 19, wherein the operations further comprise:
establishing, using the information indicative of the contact information, a connection between the device used by the consumer of services and the brokerage system.

21. The electronic system of claim 20, wherein bridging comprises:
joining the connection with the second communication channel.
